(19) United States
(12) Patent Application Publication
(10) Pub. No.: US 2021/0001254 A1
(43) Pub. Date: Jan. 7, 2021

(54) SUCTION FILTER DEVICE WITH AIR SEPARATION

(71) Applicant: IBS FILTRAN KUNSTSTOFF-/METALLERZEUGNISSE GMBH, Morsbach (DE)

(72) Inventors: Wolfgang Stausberg, Morsbach (DE); Joeri De Haas, Ter Aar (NL)

(21) Appl. No.: 16/960,157

(22) PCT Filed: Jan. 3, 2019
(86) PCT No.: PCT/EP2019/050116

§ 371 Date: Jul. 6, 2020

(30) Foreign Application Priority Data
Jan. 4, 2018 (DE) 10 2018 100 145.2

(51) Int. Cl. B01D 36/00; B01D 35/027; B01D 35/26

(52) U.S. Cl. CPC B01D 36/001; B01D 2201/204; B01D 35/26; B01D 35/0273

(57) ABSTRACT

A suction filter device for filtering oil includes a filter housing having an oil inlet opening and an oil outlet opening, via which a filter housing interior can be fluidically connected to a suction line. An oil filter medium is arranged in the filter housing interior between the oil inlet opening and the oil outlet opening, so that, by means of negative pressure generated via the suction line within the filter housing interior in relation to an environment of the filter housing, an oil flow can be generated from the oil inlet opening through the oil filter medium and through the oil outlet opening. Further, an oil-permeable and air-impermeable air separation medium is included. The air separation medium is arranged upstream of the oil outlet opening when a vacuum is generated via the suction line within the filter housing interior in relation to an environment of the filter housing.

The present invention relates to a suction filter device for an internal combustion engine or for a transmission, the suction filter device comprising an air separation apparatus.

In hydraulically powered units having rotating parts, in particular in automatic transmissions having the clutches, brakes and associated actuators arranged therein, air is incorporated into the ejected leakage and lubricating oil in a speed-dependent manner. This inevitably means that units of this kind are operated using an oil-air emulsion rather than pure oil in almost all operating states.

Due to the greater compressibility of an oil-air emulsion compared with pure oil, the functional reliability of a suction pump connected to the suction filter device is not guaranteed. This is because cavitation may occur within the suction pump due to the air trapped in the oil, and this cavitation may lead to damage to the suction pump and to greater noise generation.

Furthermore, the functional reliability of an internal combustion engine connected to the suction filter device or of an automatic transmission connected to the suction filter device is not guaranteed. This is because air trapped in the oil reduces the lubrication performance of the oil. Moreover, air trapped in the oil worsens the shifting functionality of an automatic transmission.

The problem addressed by the present invention is that of providing an improved suction filter device that reduces, or even does not exhibit, the above-described disadvantages.

The problem addressed by the present invention is solved by a suction filter device having the features of claim 1. The dependent claims describe advantageous embodiments of the suction filter device.

More specifically, the problem addressed by the present invention is solved by a suction filter device for filtering oil, wherein the suction filter device comprises a filter casing having an oil inlet opening and an oil outlet opening, by means of which a filter casing interior can be brought into fluid communication with a suction line, and an oil filter medium for filtering oil, wherein the oil filter medium is arranged in the filter casing interior between the oil inlet opening and the oil outlet opening such that an oil flow from the oil inlet opening through the oil filter medium and through the oil outlet opening can be generated by negative pressure within the filter casing interior relative to a surrounding region of the filter casing, said negative pressure being generated by means of the suction line. The suction filter device according to the invention is characterized in that the suction filter device comprises an oil-permeable air separator medium, wherein the air separator medium is arranged upstream of the oil outlet opening when the negative pressure within the filter casing interior relative to a surrounding region of the filter casing is applied, said negative pressure being generated by means of the suction line.

The suction filter device according to the invention has the advantage that a suction pump in fluid communication with the suction filter device has improved functional reliability and is exposed to reduced loads. In addition, in an internal combustion engine connected to the suction filter device according to the invention or a transmission connected to the suction filter device according to the invention (e.g. an automatic transmission), the oil lubrication is improved, and so the functional reliability thereof is also increased.

The suction filter device is designed as a suction filter device for an automobile transmission or as a suction filter device for an internal combustion engine for an automobile.

The filter casing interior is the interior of the filter casing and is thus delimited by the filter casing.

The oil flow that can be generated by negative pressure generation in the suction line is designed such that the oil outlet opening is arranged downstream of the oil filter medium, which is in turn arranged downstream of the oil inlet opening.

The feature whereby the air separator medium is arranged upstream of the oil outlet opening can also be expressed such that the air separator medium is arranged fluidically before the oil outlet opening. Therefore, as a result of the suction of oil by the suction line, the oil is suctioned or conveyed through the air separator medium before passing through the oil outlet opening.

The air separator medium should not be confused with the oil filter medium. The air separator medium preferably comprises a grating structure. Preferably, the air separator medium is made of a plastics material. Further preferably, the air separator medium is made of a metal.

Due to the position of the air separator medium, the flow rate of the oil flowing through said medium is reduced such that air bubbles can adhere to and bead off from the air separator medium in an improved manner.

Preferably, the suction filter device comprises a retaining frame connected to the filter casing and arranged outside the filter casing interior, wherein the retaining frame comprises at least one through-opening, which is closed by the air separator medium in such a way that the at least one through-opening is oil-permeable.

By designing the suction filter device accordingly, the flow rate of the oil through the air separator medium can be reduced such that air bubbles in the oil can adhere to and bead off from the air separator medium in an improved manner. Furthermore, arranging the air separator medium outside the filter casing interior counteracts the entry of air into the filter casing such that the oil filter medium has improved efficiency when filtering the oil.

The at least one through-opening is thus arranged upstream of the oil inlet opening of the filter casing.

Preferably, the retaining frame is interlockingly connected to the filter casing. Further preferably, the retaining frame is integrally bonded to the filter casing. For example, the retaining frame may be an integral component of the filter casing.

The filter casing preferably has a filter top shell half and a filter bottom shell half. Preferably, the retaining frame is interlockingly connected and/or integrally bonded to the filter top shell half. Further preferably, the retaining frame is interlockingly connected and/or integrally bonded to the filter bottom shell half.

The retaining frame and the air separator medium are preferably formed integrally with one another. Preferably, the air separator medium is injection-molded in the retaining frame. Further preferably the air separator medium is welded (for example by means of ultrasound or laser radiation), glued and/or clamped to the frame element.

The retaining frame preferably has a plurality of through-openings, each closed by an air separator medium.

Preferably, the suction filter device is designed such that the air separator medium is formed in one piece with the retaining frame.

Further preferably, the suction filter device is designed such that the retaining frame is formed around the periphery of the filter casing.

Forming the retaining frame around the periphery of the filter casing enables the through-opening(s) of the retaining frame, and thus the air separator medium, to have a larger surface area such that the flow rate of the oil through the air separator medium is reduced again, as a result of which air bubbles in the oil can adhere to and bead off from the air separator medium in an improved manner.

Further preferably, the suction filter device is designed such that the retaining frame is formed on the filter casing in a collar-like manner.

Preferably, the suction filter device comprises an oil pan and/or a motor or transmission casing part, the retaining frame being connected to the filter casing and to the oil pan and/or to the motor or transmission casing part in a fluid-tight manner.

The suction filter device designed accordingly has an improved flow of oil against the through-openings of the retaining frame.

Preferably, a filter casing bottom shell half is connected to the oil pan and/or to the motor or transmission casing part. Further preferably, a filter casing top shell half is connected to the oil pan and/or to the motor or transmission casing part.

Further preferably, the suction filter device is designed such that the retaining frame is an integral component of the oil pan and/or of the motor or transmission casing part.

The suction filter device designed accordingly has the advantage that existing filter casings can substantially continue to be used since the functionality of the air separation is provided by the oil pan and/or by the motor or transmission casing part.

Further preferably, the suction filter device is designed such that the retaining frame is interlockingly connected to the oil pan and/or to the motor or transmission casing part.

Further preferably, the suction filter device is designed such that the retaining frame is interlockingly connected to the filter casing.

Further preferably, the suction filter device is designed such that, in addition to the first oil outlet opening, the filter casing comprises a second oil outlet opening, by means of which the filter casing interior can be brought into fluid communication with a second suction line, the air separator medium being arranged upstream of the second oil outlet opening when the negative pressure within the filter casing interior relative to a surrounding region of the filter casing is applied, said negative pressure being generated by means of the second suction line.

The first oil outlet opening can also be referred to as the primary oil outlet opening and the second oil outlet opening can also be referred to as the secondary outlet opening.

In particular in automobiles having a start-stop automatic transmission, secondary suction pumps that are in fluid communication with the filter casing interior by means of the secondary outlet opening are provided. Secondary suction pumps, which may be designed, for example, as vane pumps, are particularly prone to cavitation. Therefore, the suction filter device designed accordingly has better protection for secondary suction pumps and guarantees the operational reliability thereof.

Further preferably, the suction filter device is designed such that the second oil outlet opening is arranged upstream of the oil filter medium.

Further preferably, the suction filter device is designed such that the second oil outlet opening is arranged downstream of the oil filter medium.

Further preferably, the suction filter device is designed such that, when the suction filter device is in the installed position, the air separator medium forms an angle of more than 10° with a horizontal plane at least in some portions.

By designing the suction filter device accordingly, beading of air bubbles on the air separator medium is improved since the sloped position of the air separator medium causes relatively small air bubbles to combine to form larger air bubbles, which have a greater buoyancy force in the oil and thus bead or rise off from the air separator medium in an improved manner.

Preferably, when the suction filter device is in the installation position, the air separator medium forms an angle of between 10° and 20°, further preferably between 20° and 30°, further preferably between 30° and 40°, further preferably between 40° and 50°, further preferably between 50° and 60°, further preferably between 60° and 70°, and further preferably more than 70°, with a horizontal plane at least in some portions.

Further advantages, details and features of the invention will become apparent below from the described embodiment examples. In the drawings:

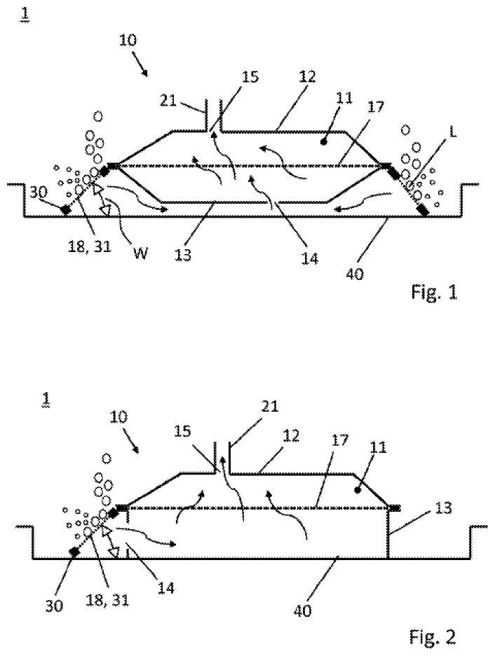

FIG. 1 is a schematic cross-sectional view of a suction filter device according to the invention in accordance with a first embodiment of the present invention;

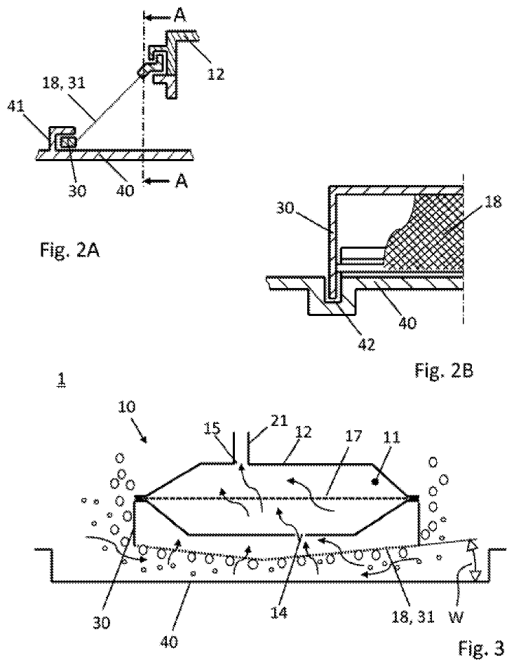

FIG. 2 is a schematic cross-sectional view of a suction filter device according to the invention in accordance with a second embodiment of the present invention;

FIG. 2A is a schematic cross-sectional view of a connection region of a retaining frame to a filter casing and to an oil pan of the suction filter device shown in FIGS. 1 and 2;

FIG. 2B is a schematic cross-sectional view of a section along the plane A-A shown in FIG. 2A;

FIG. 3 is a schematic cross-sectional view of a suction filter device according to the invention in accordance with a third embodiment of the present invention;

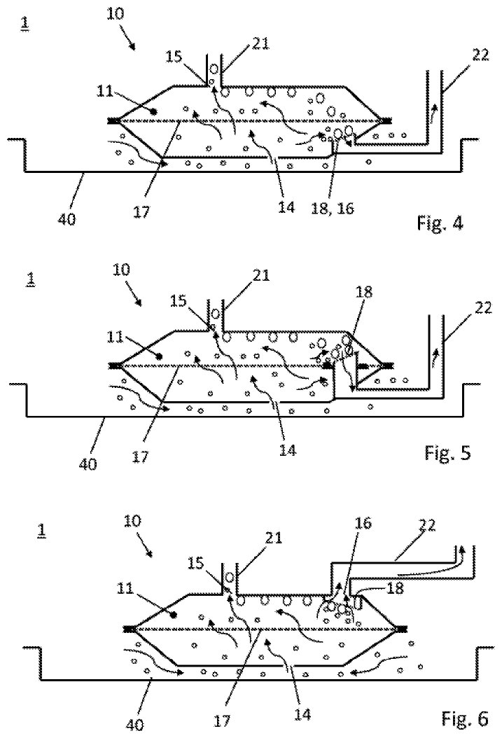

FIG. 4 is a schematic cross-sectional view of a suction filter device according to the invention in accordance with a fourth embodiment of the present invention;

FIG. 5 is a schematic cross-sectional view of a suction filter device according to the invention in accordance with a fifth embodiment of the present invention; and

FIG. 6 is a schematic cross-sectional view of a suction filter device according to the invention in accordance with a sixth embodiment of the present invention.

In the following description, like reference numerals denote like components or like features, so any description of a component given in relation to one figure also applies to the other figures, thereby avoiding a repetitive description. In addition, individual features described in connection with an embodiment can also be used separately in other embodiments.

FIG. 1 is a schematic cross-sectional view of a suction filter device 1 according to the invention in accordance with a first embodiment of the present invention. The suction filter device comprises a filter casing 10, which, in the embodiment example shown, comprises a filter casing top shell half 12 and a filter casing bottom shell half 13 connected thereto. The filter casing top shell half 12 and the filter casing bottom shell half 13 enclose a filter casing interior 11 of the filter casing 10. The filter casing 10 has an oil inlet opening 14 and an oil outlet opening 15, the oil inlet opening 14 being arranged in the filter casing bottom shell half 13 and the oil outlet opening 15 being arranged in the filter casing top shell half 12. The filter casing interior 11 can be brought into fluid communication with a suction pump (not shown in the drawings) by means of a suction line 21.

The suction filter device 1 further comprises an oil filter medium 17 for filtering oil, the oil filter medium 17 being arranged in the filter casing interior 10 between the oil inlet opening 14 and the oil outlet opening 15. Thus, an oil flow from the oil inlet opening 14 through the oil filter medium 17 and through the oil outlet opening 15 is generated by negative pressure within the filter casing interior 11 relative to a surrounding region of the filter casing 10, said negative pressure being generated by means of the suction line 21.

The suction filter device 1 according to the invention further comprises an oil-permeable air separator medium 18. The air separator medium 18 preferably comprises a grating structure and is further preferably made of a plastics material. It is also possible for the air separator medium 18 to be formed from a metal grating. The air separator medium 18 is arranged upstream of the oil outlet opening 15 when the negative pressure within the filter casing interior 11 relative to a surrounding region of the filter casing 10 is applied, said negative pressure being generated by means of the suction line 21. Since the air separator medium 18 is arranged upstream of the oil outlet opening 15, the air separator medium 18 is arranged fluidically before the oil outlet opening 15. Therefore, as a result of the suction of oil by the suction line 21, the oil is suctioned or conveyed through the air separator medium 18 before passing through the oil outlet opening 15. In the embodiment example shown in FIG. 1, the air separator medium 18 is also arranged upstream of the oil inlet opening 14.

The suction filter device 1 shown in FIG. 1 further comprises a retaining frame 30 connected to the filter casing 10 and arranged outside the filter casing interior 11. The retaining frame 30 comprises at least one through-opening 31. In the embodiment example shown, the retaining frame 30 comprises a plurality of through-openings 31. The through-openings 31 are each closed by an air separator medium 18 in such a way that the through-openings 31 are oil-permeable

It can be seen from FIG. 1 that, when the suction filter device 1 is in the installation position, the air separator medium 18 forms an angle W with a horizontal plane, which, in the embodiment example shown, coincides with a plane of extension of an oil pan 40. In the embodiment example shown, the angle W is approximately 45°. Due to a corresponding sloped position of the air separator medium 18, relatively small air bubbles L combine, due to their buoyancy force, to form larger air bubbles L, and so the air bubbles L exposed to a higher buoyancy force then detach from the air separator medium 18 and rise to an oil surface outside the filter casing 10.

The air separator medium 18 is preferably formed in one piece with the retaining frame 30. For example, the air separator medium 18 may be an integral component of the retaining frame 30. For example, the air separator medium 18 may be injection-molded in the retaining frame 30.

In the embodiment example shown, the retaining frame 30 is an integral component of the filter casing 10. In the embodiment example shown, the retaining frame 30 is formed in one piece with the filter casing bottom shell half 13.

As can be seen from FIG. 1, the retaining frame 30 is formed around the periphery of the filter casing 10. Furthermore, the retaining frame 30 is arranged on the filter casing 10 in a collar-like manner, such that the retaining frame 30 is formed so as to protrude from the filter casing 10.

The suction filter device 1 shown in FIG. 1 further comprises an oil pan 40, the retaining frame 30 being connected to both the filter casing 10 and the oil pan 40 in a fluid-tight manner. As regards the connection of the retaining frame 30 to the oil pan 40 and to the filter casing 10, reference is made to FIG. 2A and 2B, which are described further below.

Instead of an oil pan, reference sign 40 can also denote a part of a motor or transmission casing.

FIG. 2 is a schematic cross-sectional view of a suction filter device 1 according to the invention in accordance with a second embodiment of the present invention. In the suction filter device 1 according to the second embodiment, the filter casing bottom shell half 13 is connected to the oil pan 40 in one piece. The oil inlet opening 14 is formed by a side opening in the filter casing bottom shell half 13. The retaining frame 30 is provided upstream of the oil inlet opening 14, an air separator medium 18 being inserted into the through-opening 31 in said retaining frame. The air separator medium 18 shown in FIG. 2 also forms an angle W of approximately 45° together with a horizontal plane.

FIG. 2A is a schematic cross section of a connection region of the retaining frame 30 to the oil pan 40 and to the filter casing 10. It can be seen that the oil pan 40 comprises a fastening projection 41 with which the retaining frame 30 engages. It can also be seen that the filter casing top shell half 12 also comprises a corresponding fastening projection with which the retaining frame 30 also engages.

FIG. 2B shows a connection region of the suction filter device 1, the cross-sectional view according to FIG. 2B showing the suction filter device 1 along the plane A-A shown in FIG. 2A. It can be seen that the oil pan 40 comprises a retaining groove 42 with which the retaining frame 30 engages.

It can be seen from FIG. 2A and 2B that the retaining frame 30 is interlockingly connected to the oil pan 40 and also to the filter casing 10 in such a way that the labyrinthine shape of the contact surfaces of the retaining frame 30 with both the oil pan 40 and the filter casing 10 causes air bubbles to unavoidably pass through the air separator medium 18.

FIG. 3 is a schematic cross-sectional view of a suction filter device 1 according to a third embodiment of the present invention. In the suction filter device 1 according to the third embodiment, the through-opening 31 of the retaining frame 30 is arranged on the underside of the retaining frame 30 and is also closed by an air separator medium 18. The angle W that the air separator medium 18 forms with the horizontal plane is smaller in the embodiment example shown in FIG. 3 than in the embodiment examples shown in FIGS. 1 and 2.

FIG. 4 is a schematic cross-sectional view of a suction filter device 1 according to a fourth embodiment of the present invention. In addition to a first oil outlet opening 15, the filter casing 1 comprises a second oil outlet opening 16. The first oil outlet opening 15 can also be referred to as the primary oil outlet opening 15 and the second oil outlet opening 16 can also be referred to as the secondary oil outlet opening 16. The filter casing interior 11 is in fluid communication with a second suction line 22, which can also be referred to as the secondary suction line 22, by means of the second oil outlet opening 16. The air separator medium 18 is arranged upstream of the second oil outlet opening 16 when the negative pressure within the filter casing interior 11 relative to a surrounding region of the filter casing 10 is applied, said negative pressure being generated by means of the second suction line 22. In the embodiment example shown, the air separator medium 18 is arranged upstream of the oil filter medium 17. In the suction filter device 1 according to the fourth embodiment, the air separator medium 18 also forms an angle W with the horizontal plane, said angle being approximately 20° in the embodiment example shown.

FIG. 5 shows a suction filter device 1 according to a fifth embodiment of the present invention. The suction filter device 1 according to the fifth embodiment is identical to the suction filter device 1 according to the fourth embodiment, although the second suction line 22 protrudes through the oil filter medium 12 such that the second oil outlet opening 16 is arranged downstream of the oil filter medium 17.

The suction filter device 1 according to the fourth embodiment and according to the fifth embodiment share the feature whereby the respective second oil outlet openings 16 are each arranged in the filter casing bottom shell half 13.

FIG. 6 is a schematic cross-sectional view of a suction filter device 1 according to a sixth embodiment of the present invention. The suction filter device 1 shown in FIG. 6 is identical to the suction filter device 1 shown in FIG. 5, although the second suction line 22 is attached to the filter casing top shell half 12. The second oil outlet opening 16 is thus also provided on the filter casing top shell half 12. The rest of the structure of the suction filter device 1 according to the sixth embodiment is identical to the configuration of the suction filter device 1 according to the fifth embodiment.

### LIST OF REFERENCE SIGNS

1 Suction filter device
10 Filter casing
11 Filter casing interior
12 Filter casing top shell half/filter top shell half
13 Filter casing bottom shell half/filter bottom shell half
14 Oil inlet opening
15 (First) oil outlet opening/primary oil outlet opening
16 Second oil outlet opening/secondary oil outlet opening
17 Oil filter medium
18 Air separator medium
21 (First) suction line/primary suction line
22 Second suction line/secondary suction line
30 Retaining frame
31 Through-opening (in the retaining frame)
40 Oil pan/part of a motor or transmission casing
41 Fastening projection (of the oil pan)
42 Retaining groove (in the oil pan)
L Air bubbles
W Angle (between the air separator medium and a horizontal plane)

1. A suction filter device for filtering oil, comprising
a filter casing having an oil inlet opening and an oil outlet opening, by means of which a filter casing interior can be brought into fluid communication with a suction line; and
at least one oil filter medium for filtering oil, said oil filter medium being arranged in the filter casing interior between the oil inlet opening and the oil outlet opening such that an oil flow from the oil inlet opening through the oil filter medium and through the oil outlet opening can be generated by negative pressure within the filter casing interior relative to a surrounding region of the filter casing, said negative pressure being generated by means of the suction line,
wherein:
the suction filter device comprises an oil-permeable air separator medium;
the air separator medium is arranged upstream of the oil outlet opening when the negative pressure within the filter casing interior relative to a surrounding region of the filter casing is applied, said negative pressure being generated by means of the suction line.

2. The suction filter device according to claim 1,
wherein the suction filter device further comprises a retaining frame connected to the filter casing and arranged outside the filter casing interior; and
wherein the retaining frame comprises at least one through-opening, which is closed by the air separator medium in such a way that the at least one through-opening is oil-permeable.

3. The suction filter device according to claim 2, wherein the air separator medium is formed in one piece with the retaining frame.

4. The suction filter device according to claim 2, wherein the retaining frame is formed around the periphery of the filter casing.

5. The suction filter device according to claim 2, wherein the retaining frame is arranged on the filter casing in a collar-like manner.

6. The suction filter device according to claim 2, wherein:
the suction filter device comprises an oil pan and/or a motor or transmission casing part; and
the retaining frame is connected to the filter casing and to the oil pan and/or to the motor or transmission casing part in a fluid-tight manner.

7. The suction filter device according to claim 6, wherein the retaining frame is an integral component of the oil pan and/or of the motor or transmission casing part.

8. The suction filter device according to claim 6, wherein the retaining frame is interlockingly connected to the oil pan and/or to the motor or transmission casing part.

9. The suction filter device according to claim 2, wherein the retaining frame is interlockingly connected to the filter casing.

10. The suction filter device according to claim 1, wherein:
the suction filter device further comprises a second oil outlet opening on the suction filter, by means of which the filter casing interior can be brought into fluid communication with a second suction line;
the air separator medium is arranged upstream of the second oil outlet opening when the negative pressure within the filter casing interior 0 relative to a surrounding region of the filter casing is applied, said negative pressure being generated by means of the second suction line.

11. The suction filter device according to claim 10, wherein the second oil outlet opening is arranged upstream of the oil filter medium.

12. The suction filter device according to claim 10, wherein the second oil outlet opening is arranged downstream of the oil filter medium.

13. The suction filter device according to claim 1, wherein, when the suction filter device is in the installed position, the air separator medium forms an angle of more than 10° with a horizontal plane at least in some portions.
